(19) United States
(12) Patent Application Publication
(10) Pub. No.: US 2025/0050759 A1
(43) Pub. Date: Feb. 13, 2025

(54) MULTI-LEVEL MULTI-FUNCTION INVERTER

(71) Applicant: GM Global Technology Operations LLC, Detroit, MI (US)

(72) Inventors: Chandra S. Namuduri, Troy, MI (US); Muhammad Hussain Alvi, Troy, MI (US); Rashmi Prasad, Troy, MI (US); Khorshed Mohammed Alam, Canton, MI (US); Junghoon Kim, Ann Arbor, MI (US); Yilun Luo, Ann Arbor, MI (US)

(21) Appl. No.: 18/448,376

(22) Filed: Aug. 11, 2023

(51) Int. Cl. B60L 53/24; B60L 53/10; B60L 53/22; H02M 7/487

(52) U.S. Cl. CPC B60L 53/24; B60L 53/11; B60L 53/22; H02M 7/487; B60L 2210/40

(57) ABSTRACT

A vehicle includes a system for charging a battery of the vehicle. The system includes an electric motor couplable to a charging station, a capacitor-clamped multi-level inverter, and a processor. The capacitor-clamped multi-level inverter is couples the electric motor to the battery and includes a first leg having a first set of switches and a first AC terminal coupled to the electric motor, a second leg having a second set of switches and a second AC terminal coupled to the electric motor and a third leg having a third set of switches and a third AC terminal coupled to the electric motor. The processor connects one of the third AC terminal and a neutral point of the electric motor to the charging station and control at least one of the first set of switches and the second set of switches to charge the battery through the electric motor.

### INTRODUCTION

The subject disclosure relates to charging a battery of an electric vehicle and, in particular, to a method of operating switches of a multi-level inverter to control the charging operation.

Electric vehicles are being produced that have battery capacities that exceed the charging capacities of currently available charging stations. To support the backward compatibility of these electric vehicles, many have been equipped with additional on-board electronics in the form of a direct current (DC-DC) converter. However, such additional on-board electronics are undesirable because they increase the complexity of the vehicle as well as its mass and volume. Accordingly, it is desirable to provide a method of charging the vehicle at currently available charging stations without the need for the additional on-board electronics to provide backward compatibility.

### SUMMARY

In one exemplary embodiment, a method of charging a battery of an electric vehicle is disclosed. A charging station is coupled to an electric motor of the electric vehicle, wherein the electric motor is coupled to the battery by a capacitor-clamped multi-level inverter that includes a first leg having a first set of switches and a first alternating current (AC) terminal coupled to the electric motor, a second leg having a second set of switches and a second AC terminal coupled to the electric motor and a third leg having a third set of switches and a third AC terminal coupled to the electric motor. One of the third AC terminal of the third leg of the capacitor-clamped multi-level inverter and a neutral point of the electric motor is connected to the charging station. At least one of the first set of switches to control a first current through the first AC terminal of the first leg and the second set of switches to control a second current through the second AC terminal of the second leg to charge the battery via the charging station through the electric motor. At least one of the first set of switches and the second set of switches is controlled to control, respectively, a first current through the first AC terminal of the first leg and a second current through the second AC terminal of the second leg to charge the battery via the charging station through the electric motor.

In addition to one or more of the features described herein, controlling the first current further includes controlling a first switching cycle for the first set of switches of the first leg and controlling the second current further includes controlling a second switching cycle for the second set of switches of the second leg.

In addition to one or more of the features described herein, the first leg includes a switch pair and switches of the switch pair receive inputs that are out of phase by 180 degrees.

In addition to one or more of the features described herein, the method further includes controlling a first magnitude of the first current and a second magnitude of the second current to generate a net zero torque at the electric motor for any angular location of a rotor of the electric motor.

In addition to one or more of the features described herein, wherein the third AC terminal is connected to the charging station, further comprising placing each switch of the third set of switches in an open state.

In addition to one or more of the features described herein, wherein the third AC terminal is connected to the charging station and the third set of switches includes four switches in series, the method further includes placing a first switch and a third switch of the third leg in a closed state and placing a second switch and a fourth switch of the third leg in an open state to connect a clamping capacitor of the third leg across the charging station.

In addition to one or more of the features described herein, wherein the neutral point of the electric motor is connected to the charging station, the method further includes operating the first set of switches, the second set of switches and the third set of switches out of phase with each other by 120 degrees.

In another exemplary embodiment, a system for charging a battery of a vehicle is disclosed. The system includes an electric motor couplable to a charging station, a capacitor-clamped multi-level inverter, and a processor. The capacitor-clamped multi-level inverter is configured to couple the electric motor to the battery and includes a first leg having a first set of switches and a first AC terminal coupled to the electric motor, a second leg having a second set of switches and a second AC terminal coupled to the electric motor and a third leg having a third set of switches and a third AC terminal coupled to the electric motor. The processor is configured to connect one of the third AC terminal of the third leg of the capacitor-clamped multi-level inverter and a neutral point of the electric motor to the charging station, and control at least one of the first set of switches to control a first current through the first AC terminal of the first leg and the second set of switches to control a second current through the second AC terminal of the second leg to charge the battery via the charging station through the electric motor.

In addition to one or more of the features described herein, the processor is further configured to control the first current by controlling a first switching cycle for the first set of switches of the first leg and to control the second current by controlling a second switching cycle for the second set of switches of the second leg.

In addition to one or more of the features described herein, the first leg includes a switch pair and the processor is further configured provide a carrier signal to the switch pair, wherein switches of the switch pair receive inputs that are out of phase by 180 degrees.

In addition to one or more of the features described herein, the processor is further configured 50 control a first magnitude of the first current and a second magnitude of the second current to generate a net zero torque at the electric motor for any angular location of a rotor of the electric motor.

In addition to one or more of the features described herein, the third AC terminal is connected to the charging station and the processor is further configured to place each switch of the third set of switches in an open state.

In addition to one or more of the features described herein, the third AC terminal is connected to the charging station and the third set of switches includes four switches in series and the processor is further configured to place a first switch and a third switch of the third leg in a closed state and place a second switch and a fourth switch of the third leg in an open state to connect a clamping capacitor of the third leg across the charging station.

In addition to one or more of the features described herein, the neutral point of the electric motor is connected to the charging station and the processor is further configured to operate the first set of switches, the second set of switches and the third set of switches out of phase with each other by 120 degrees.

In yet another exemplary embodiment, a vehicle is disclosed. The vehicle includes a battery, an electric motor couplable to a charging station, a capacitor-clamped multi-level inverter, and a processor. The capacitor-clamped multi-level inverter is configured to couple the electric motor to the battery and includes a first leg having a first set of switches and a first AC terminal coupled to the electric motor, a second leg having a second set of switches and a second AC terminal coupled to the electric motor and a third leg having a third set of switches and a third AC terminal coupled to the electric motor. The processor is configured to connect one of the third AC terminal of the third leg of the capacitor-clamped multi-level inverter and a neutral point of the electric motor to the charging station and control at least one of the first set of switches to control a first current through the first AC terminal of the first leg and the second set of switches to control a second current through the second AC terminal of the second leg to charge the battery via the charging station through the electric motor.

In addition to one or more of the features described herein, the processor is further configured to control the first current by controlling a first switching cycle for the first set of switches of the first leg and to control the second current by controlling a second switching cycle for the first set of switches of the second leg.

In addition to one or more of the features described herein, the first leg includes a switch pair and the processor is further configured provide a carrier signal to the switch pair, wherein switches of the switch pair receive inputs that are out of phase by 180 degrees.

In addition to one or more of the features described herein, the processor is further configured to control a phase between the first current and the second current to generate a net zero torque at the electric motor for any angular location of a rotor of the electric motor.

In addition to one or more of the features described herein, the third AC terminal is connected to the charging station, the third set of switches including four switches in series and the processor is further configured to place each switch of the third set of switches in an open state.

In addition to one or more of the features described herein, the third AC terminal is connected to the charging station, the third set of switches including four switches in series and the processor is further configured to place a first switch and a third switch of the third leg in a closed state and place a second switch and a fourth switch of the third leg in an open state to connect a clamping capacitor of the third leg across the charging station.

In addition to one or more of the features described herein, the neutral point of the electric motor is connected to the charging station and the processor is further configured to operate the first set of switches, the second set of switches and the third set of switches out of phase with each other by 120 degrees.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a charging circuit for charging the electric vehicle, in an embodiment;

FIG. 3 is a schematic diagram showing details of the electric motor and the inverter;

FIG. 4 is a schematic diagram shows the electric motor, the inverter, and an inverter control circuit;

FIG. 5 is a schematic diagram showing details of the electric motor, the inverter and the inverter control circuit in another embodiment;

FIG. 6 shows a phase diagram of the electric motor, in an embodiment;

FIG. 7 shows a phase diagram of the electric motor in another embodiment;

FIG. 8 shows a phase diagram of the electric motor in another embodiment;

FIG. 9 shows the inverter in a configuration for charging the battery using a three-phase electric motor, in another embodiment;

FIG. 10 shows the inverter in a configuration for charging the battery using a three-phase electric motor, in another embodiment; and

FIG. 11 shows the inverter in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

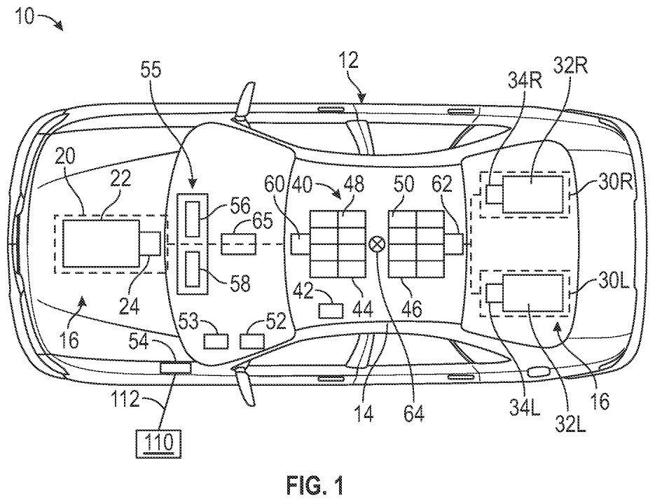

In accordance with an exemplary embodiment, FIG. 1 shows a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes an electric motor 32L and an inverter 34L. A right rear drive unit 30R includes an electric motor 32R and an inverter 34R. The inverters 24, 34L and 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 and rear electric motors 32L and 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives front wheels (not shown) and the rear electric motors 32L and 32R drive rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

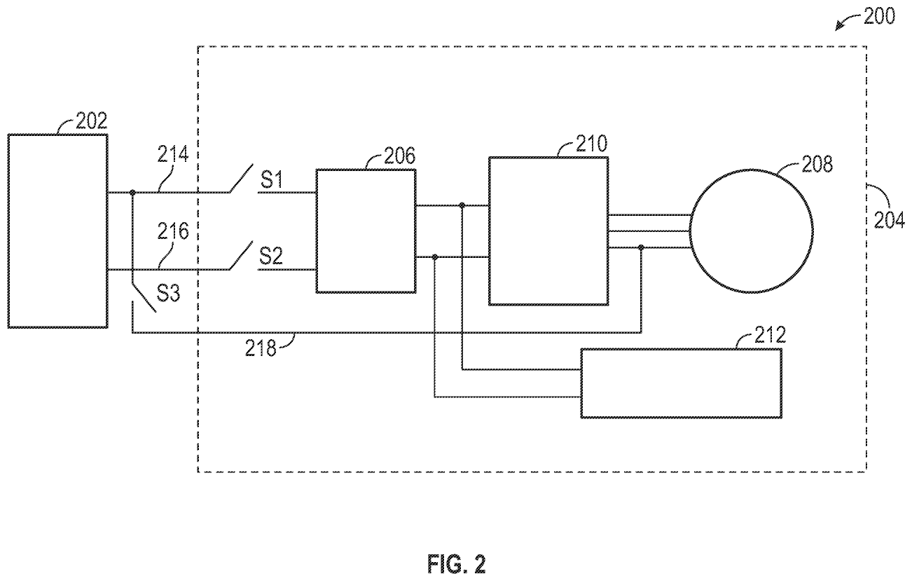

In an embodiment, the battery system 40 includes a plurality of separate battery assemblies, in which each battery assembly can be independently charged and can be used to independently supply power to a drive system or systems. For example, the battery system 40 includes a first battery assembly such as a first battery sub-pack 44 connected to the front inverter 24, and a second battery sub-pack 46. The first battery sub-pack 44 includes a plurality of battery modules 48, and the second battery sub-pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery, as described herein with respect to FIGS. 2-4.

Each of the front electric motor 22 and the rear electric motors 32L and 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the battery packs 44 and 46, and selectively connecting the battery packs 44 and 46 to the front drive unit 20, left rear drive unit 30L and right rear drive unit 30R. The switching devices may also be operated to selectively connect the first battery sub-pack 44 and the second battery sub-pack 46 to a charging system. The charging system can be used to charge the first battery sub-pack 44 and the second battery sub-pack 46, and/or to supply power from the first battery sub-pack 44 and/or the second battery sub-pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC). As shown in FIG. 1, the utility AC power supply is a charging station 110 that is connected to the charge port 54 via a cord 112.

In an embodiment, the switching system includes a first switching device 60 that selectively connects the first battery sub-pack 44 to the inverters 24, 34L and 34R, and a second switching device 62 that selectively connects the second battery sub-pack 46 to the inverters 24, 34L and 34R. The switching system also includes a third switching device 64 (also referred to as a “battery switching device”) for selectively connecting the first battery sub-pack 44 to the second battery sub-pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 65 may include a non-transitory computer-readable medium that stores instructions which, when processed by one or more processors of the controller 65, implement a method of charging a battery, according to one or more embodiments detailed herein. Such method includes operating various control blocks and switches of the vehicle, as discussed herein.

FIG. 2 shows a charging circuit 200 for charging the electric vehicle 10 in an embodiment. The charging circuit 200 shows the charging station 202 and vehicle electronics 204. The vehicle electronics 204 includes a battery 206 or power source, an electric motor 208 and an inverter 210 that couples the battery to the electric motor and converts direct current (DC) power from the battery into alternating current (AC) power for use at the motor. In various embodiments, the battery 206 is a single battery or multiple batteries that has a total voltage capacity of +800 Volts. The inverter 210 is a multi-level capacitor-clamped inverter that includes a leg for each phase winding of the electric motor 208. In various embodiments, the electric motor 208 is a three-phase motor with three phase windings. Thus, the inverter 210 includes three legs. The vehicle electronics 204 further includes accessory loads 212, which generally have +800V power capacities and which are connected directly to the battery 206.

The battery can be connected to the charging station by positive DCFC bus 214 and negative DCFC bus 216. Positive DCFC bus 214 includes a first switch S1 and negative DCFC bus 216 includes a second switch S2, which are placed in an open configuration to disconnect from the charging station and in a closed configuration to connect to the charging station. A bypass line 218 connects from the positive DCFC bus 214 to a phase winding of the electric motor 208, thus providing a second channel for charging the battery 206. A bypass switch S3 on the bypass line 218 can be placed in a closed position to selectively implement of the second channel.

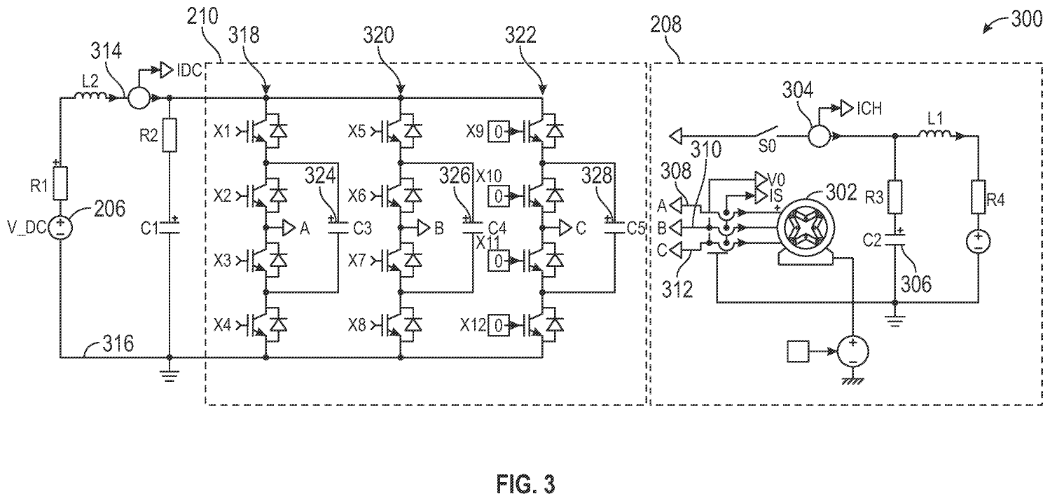

FIG. 3 is a schematic diagram 300 showing details of the electric motor 208 and the inverter 210. The electric motor 208 includes a rotor with a first phase winding 308 (labelled “A”), second phase winding 310 (labelled “B”) and third phase winding 312 (labelled “C”). The electric motor 208 connects to the charging station 202 through charging bus 304. A filter capacitor 306 controls a voltage level at the electric motor 302 by preventing or reducing spikes in the charging voltage.

The inverter 210 is connected to battery 206 via a positive DC voltage bus 314 and a negative DC voltage bus 316. The inverter 210 includes a first leg 318, a second leg 320 and a third leg 322, each of which extend between the positive DC voltage bus 314 and the negative DC voltage bus 316. Each leg includes four switches in series and a clamping capacitor. For example, the first leg 318 includes switches X1, X2, X3 and X4. The first phase winding 308 of the electric motor 302 connects to the first leg 318 at a first AC terminal between the second switch X2 and third switch X3. A first clamping capacitor 324 (labelled “C3”) connects at one end between the first switch X1 and the second switch X2 and at another end between the third switch X3 and the fourth switch X4. Similarly, the second leg 320 includes switches X5, X6, X7 and X8, with second clamping capacitor 326. The second phase winding 310 of the electric motor 302 connects to the second leg 320 at a second AC terminal between switches X6 and X7. The third leg 322 includes switches X9, X10, X11 and X12, with a third clamping capacitor 328. The third phase winding 312 of the electric motor 302 connects to the third leg 322 at a third AC terminal between switches X10 and X11.

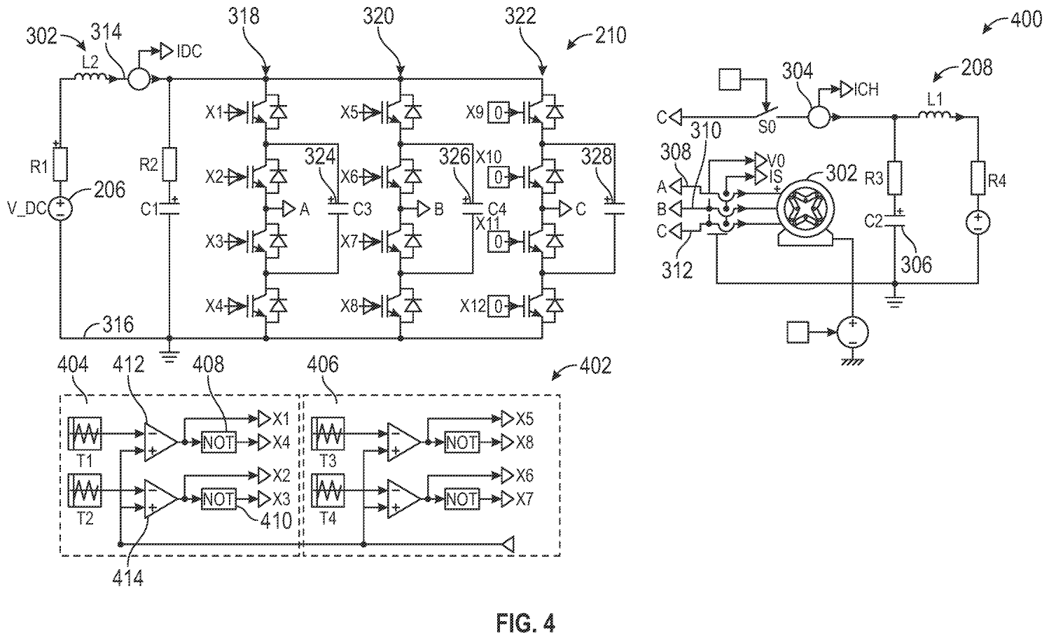

FIG. 4 is a schematic diagram 400 that shows the electric motor 208, the inverter 210, and an inverter control circuit 402. The inverter control circuit 402 is used to control the flow of current through the legs of the inverter during a charging scenario for the battery. The inverter control circuit 402 includes a first control block 404 for controlling the switches (X1, X2, X3, X4) of the first leg 318 and a second control block 406 for controlling the switches (X5, X6, X7, X8) of the second leg 320. Although not shown in FIG. 4, a third control block can be used to control the switches (X9, X10, X11, X12) of the third leg 322.

The operation of the control blocks is discussed using the first control block 404 as an illustrative example. The first control block 404 provides control signals to the switches (X1, X2, X3, X4) as grouped in switch pairs, namely, a first switch pair [X1, X4] and a second switch pair [X2, X3].

The first switch pair [X1, X4] is driven by complementary control inputs. For example, a logic inverter 408 at switch X4 ensures that switch X4 is off when X1 is on and that switch X4 is on when X1 is off. The second switch pair [X2, X3] operates similarly, with a logic inverter 410 at the third switch X3.

A first control branch of the first control block 404 includes a first carrier signal T1 that provides a first switching cycle that is input to a first comparator 412. The first comparator 412 also receives a duty cycle signal and compares the first carrier signal T1 to the duty cycle signal to provide output that is sent to the first switch pair [X1, X4].

Similarly, a second control branch of the first control block 404 includes a second carrier signal T2 that provides a second switching cycle that that is input to a second comparator 414. The second comparator also receives the same duty cycle signal and compares the second carrier signal T2 to the duty cycle signal to provide output that is sent to the second switch pair [X2, X3]. The first carrier signal is 180 degrees shifted in phase from the second carrier signal. This results in switch pairs [X1, X4] and [X2, X3] being out of phase with each other by 180 degrees. In other words, switch X1 and switch X2 are out of phase with each other by 180 degrees within a switching cycle and switch X3 and switch X4 are out of phase with each other by 180 degrees within the switching cycle.

The second control block 406 operates similarly to the first control block 404, using carrier signals T3 and T4 controlling switch pairs [X5, X8] and [X6, X7], respectively. The carrier signal T3 and the carrier signal T4 are phase-shifted with respect to each other by 180 degrees. In addition, the carrier signal for T3 is phase-shifted by 180 degrees with respect to carrier signal T1. In an embodiment, the duty cycle is a single duty cycle that is applied across the first control block 404 and the second control block 406 (and the third control block, if needed). The first control block 404 and the second control block 406 can receive either the same duty cycle signal or different duty cycle signals.

In a charging scenario, the switches (X9, X10, X11, X12) of the third branch are all turned off and the charging station ICH is connected to the third AC terminal. The first control block 404 and the second control block 406 are used to control the flow of a first current through the first leg 318 and of a second current the second leg 320, respectively. In another embodiment, the switches of the first leg 318 can be turned off and the charging station ICH is connected to the first AC terminal while the second control block 406 and the third control block are used to control the flow of a current through the second leg 320 and a current through the third leg 322, respectively. In yet another embodiment, the switches of the second branch can be turned off and the charging station ICH is connected to the second AC terminal while the first control block 404 and the third control block are used to control the flow of current through the first leg 318 and current through the third leg 322, respectively.

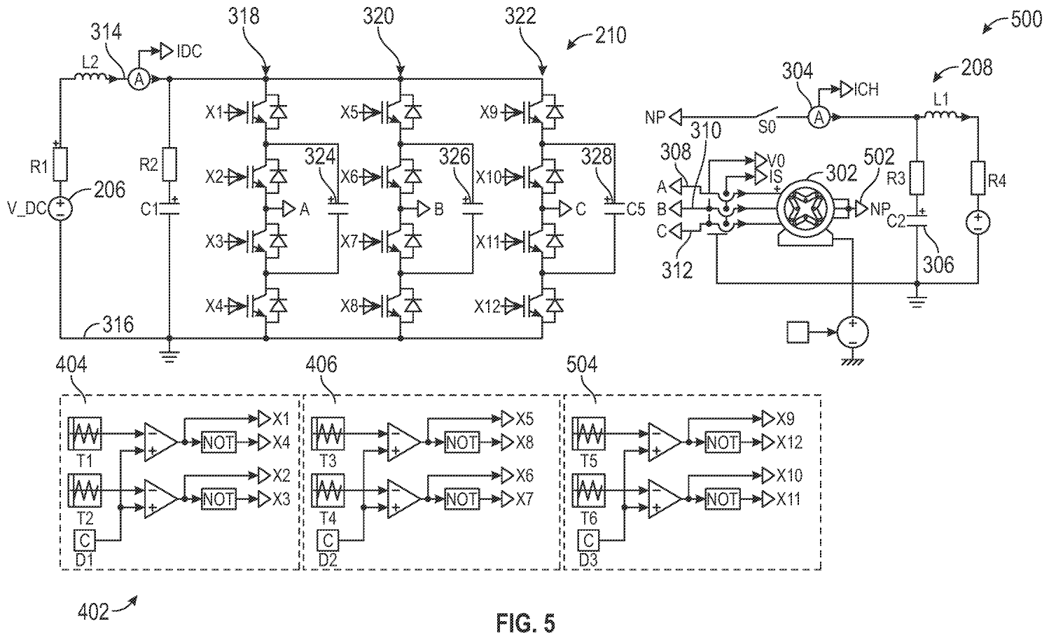

FIG. 5 is a schematic diagram 500 showing details of the electric motor 208, the inverter 210 and the inverter control circuit 402 in another embodiment. The electric motor 208 includes a first phase winding A 308, second phase winding B 310, third phase winding C 312 and a neutral point 502. The neutral point 502 of the electric motor 208 connects to the charging station through charging bus 304.

The inverter control circuit 402 includes a first control block 404 for controlling switches (X1, X2, X3, X4) of the first leg 318, a second control block 406 for controlling switches (X5, X6, X7, X8) of the second leg 320 and a third control block 504 for controlling switches (X9, X10, X11, X12) of the third leg 322. Each control block is driven by an independent duty cycle signal (i.e., first duty cycle signal D1 for the first control block 404, second duty cycle D2 for the second control block 406 and third duty cycle signal D3 for the third control block 504).

The first control block 404 is operated so that switch pairs [X1, X4] and [X2, X3] are out of phase with each other by 180 degrees, as discussed with respect to FIG. 4 Similarly, the second control block 406 is operated so that switch pairs [X5, X8] and [X6, X7] are out of phase with each other by 180 degrees, and the third control block 504 is operated so that switch pairs [X9, X12] and [X10, X11] are out of phase with each other by 180 degrees. The first control block 404, second control block 406 and third control block 504 are operated out of phase with each other by 120 degrees. For example, carrier signal T3 lags carrier signal T1 by 120 degrees of phase and carrier signal T5 lags carrier signal T3 by 120 degrees.

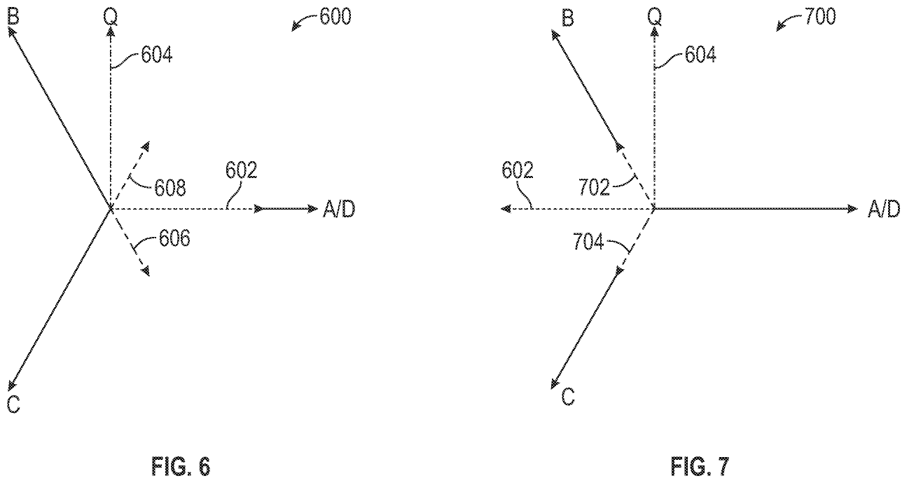

FIG. 6 shows a phase diagram 600 of the electric motor 302, in an embodiment. The phase diagram 600 includes a first phase branch A representing the current phase through the first phase winding 308, a second phase branch B representing the current phase through the second phase winding 310 and a third phase branch C representing the current phase through the third phase winding 312. Phases branches A, B and C are 120 degrees out of phase with each other. A direct axis 602 (D) and quadrature axis 604 (Q) of a rotor of the electric motor 302 are shown on the phase diagram 600. The direct axis 602 is aligned along the first phase branch A for illustrative purposes. To ensure a net zero torque production or minimal torque production at the rotor, the current is controlled to create a net current vector along the D axis. This can be achieved, for example, by connecting the charging station to first phase winding 308 (aligned with +D axis) and then controlling the negative current (i.e., current from the charging station to the battery) to be equal in magnitude through the second phase winding B and third phase winding C. The current through the second phase winding B generates a first negative torque vector 606 and the current through the third phase winding C generates a second negative torque vector 608. The magnitude of the first negative torque vector 606 is equal to the magnitude of the second negative torque vector 608. Thus, the sum of these torque vectors lies along the direct axis 602 (i.e., along the first phase branch A).

FIG. 7 shows a phase diagram 700 of the electric motor in another embodiment. The direct axis 602 is aligned opposite the first phase branch A. Current is controlled through the second phase winding B to create a first positive torque vector 702. Current is also controlled through the third phase winding C to create a second positive torque vector 704. The sum of these torque vectors lies along the direct axis 602 (lying anti-parallel to the first phase branch A).

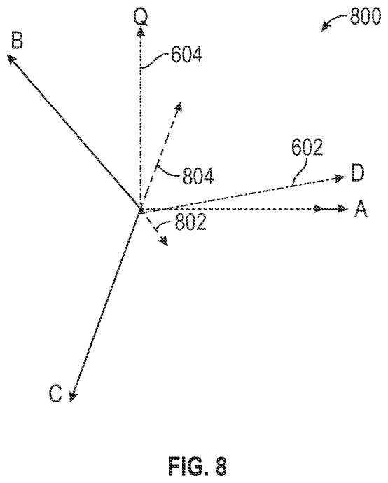

FIG. 8 shows a phase diagram 800 of the electric motor in another embodiment. The direct axis 602 of the rotor is not aligned with the phase axes A. The current can be controlled to have different currents in the second phase winding B and the third phase winding C, resulting in a first torque vector 802 and a second torque vector 804 which have different magnitudes. The summation of these torque vectors results in the combined torque that is along the D axis. Thus, for any angular position of the D axis of the rotor, an appropriate leg of the inverter can be turned off and the current through the remaining legs can be controlled appropriately to provide the required torque vector along the D axis.

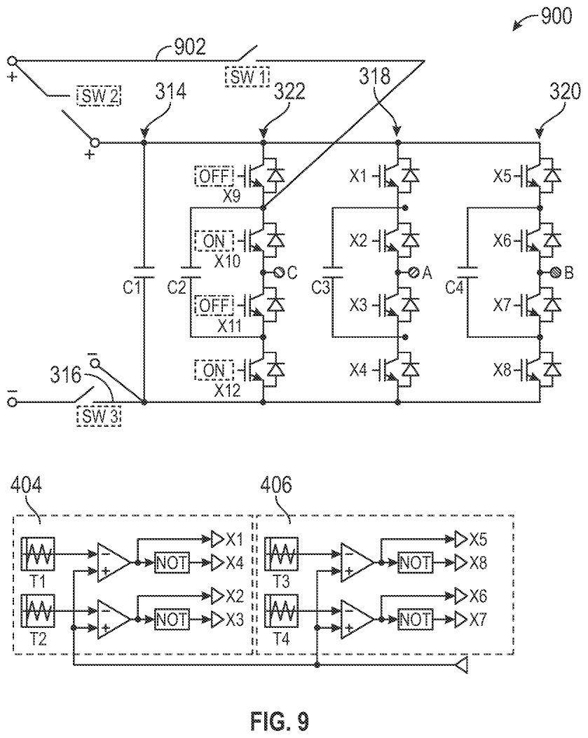

FIG. 9 shows the inverter 900 in a configuration for charging the battery using a three-phase electric motor, in another embodiment. The third leg 322 is placed with the switches X9 and X11 in an OFF state and the switches X10 and X12 in an ON state. A first auxiliary branch 902 connects the positive DC voltage bus 314 either at the third AC terminal (as shown) or to a node between the switch X9 and the switch X10. A first auxiliary branch switch SW1 is used to control the connection of the first auxiliary branch 902. Due to the configuration of the switches (X9, X10, X11, X12) along the third leg 322, opening the first auxiliary branch switch SW1 places the voltage (V_{A}) along the third phase winding 322 at V+ and closing the first auxiliary branch switch SW1 charges the clamping capacitor C2, placing the voltage (V_{A}) along the third phase winding 322 at the voltage of the capacitor (V_{C2}). The first control block 404 and second control block 406 control flow of the current through the first leg 318 and second leg 320, respectively. The clamping capacitor C2 can thus take the place of the filter capacitor 306 (FIG. 3) to filter the DCFC from the charging station 110 during a charging operation.

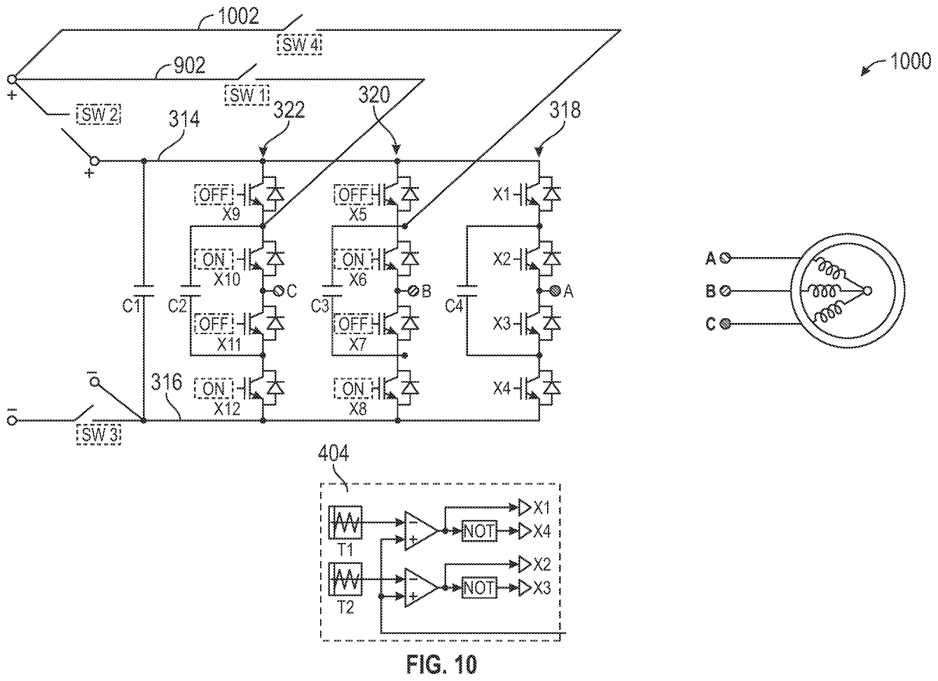

FIG. 10 shows the inverter 1000 in a configuration for charging the battery using a three-phase electric motor, in another embodiment. The third leg 322 is placed with the switches X9 and X11 in an OFF state and the switches X10 and X12 in an ON state. A first auxiliary branch 902 connects the positive DC voltage bus 314 either at the third AC terminal (as shown) or to a node between the switch X9 and the switch X10. The second leg 320 is placed with the switches X5 and X7 in an OFF state and the switches X6 and X8 in an ON state. A second auxiliary branch 1002 connects the positive DC voltage bus 314 either at the second AC terminal (as shown) or to a node between the switch X5 and the switch X6. The first control block 404 controls the flow of current through the first leg 318. With switches SW1 and SW2 in a closed configuration, capacitors C2 and C3 combined to serve as the filter capacitor 306 (FIG. 3) to filter the DCFC from the charging station 110 during a charging operation.

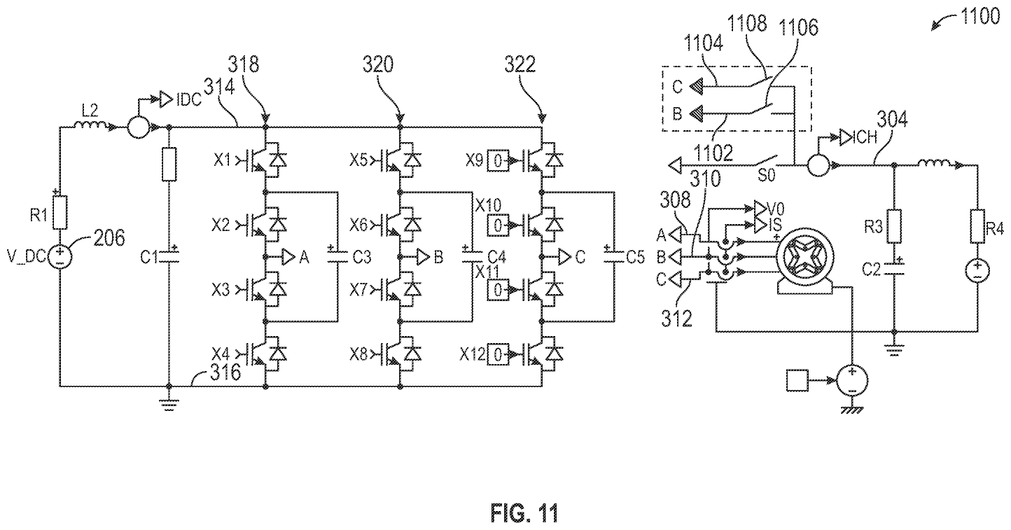

FIG. 11 shows the inverter 1100 in another embodiment. The charging bus 304 includes a first charging line 1102 connecting to the second phase winding 310 and a second charging line 1104 connecting to the third phase winding 312. The first charging line 1102 includes a first charging line switch 1106 and the second charging line 1104 includes a second charging line switch 1108. The first charging line switch 1106 and the second charging line switch 1108 can be operated to provide a multiplexed input phase, thereby minimizing the stresses on the motor during the charging procedure.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of charging a battery of an electric vehicle, comprising:
coupling a charging station to an electric motor of the electric vehicle, wherein the electric motor is coupled to the battery by a capacitor-clamped multi-level inverter that includes a first leg having a first set of switches and a first alternating current (AC) terminal coupled to the electric motor, a second leg having a second set of switches and a second AC terminal coupled to the electric motor and a third leg having a third set of switches and a third AC terminal coupled to the electric motor;
connecting one of the third AC terminal of the third leg of the capacitor-clamped multi-level inverter and a neutral point of the electric motor to the charging station; and
controlling at least one of the first set of switches to control a first current through the first AC terminal of the first leg and the second set of switches to control a second current through the second AC terminal of the second leg to charge the battery via the charging station through the electric motor.

2. The method of claim 1, wherein controlling the first current further comprises controlling a first switching cycle for the first set of switches of the first leg and controlling the second current further comprises controlling a second switching cycle for the second set of switches of the second leg.

3. The method of claim 2, wherein the first leg includes a switch pair and switches of the switch pair receive inputs that are out of phase by 180 degrees.

4. The method of claim 1, further comprising controlling a first magnitude of the first current and a second magnitude of the second current to generate a net zero torque at the electric motor for any angular location of a rotor of the electric motor.

5. The method of claim 1, wherein the third AC terminal is connected to the charging station, further comprising placing each switch of the third set of switches in an open state.

6. The method of claim 1, wherein the third AC terminal is connected to the charging station and the third set of switches includes four switches in series, further comprising placing a first switch and a third switch of the third leg in a closed state and placing a second switch and a fourth switch of the third leg in an open state to connect a clamping capacitor of the third leg across the charging station.

7. The method of claim 1, wherein the neutral point of the electric motor is connected to the charging station, further comprising operating the first set of switches, the second set of switches and the third set of switches out of phase with each other by 120 degrees.

8. A system for charging a battery of a vehicle, comprising:
an electric motor couplable to a charging station;
a capacitor-clamped multi-level inverter that includes a first leg having a first set of switches and a first AC terminal coupled to the electric motor, a second leg having a second set of switches and a second AC terminal coupled to the electric motor and a third leg having a third set of switches and a third AC terminal coupled to the electric motor, wherein the capacitor-clamped multi-level inverter is configured to couple the electric motor to the battery;
processor configured to:
connect one of the third AC terminal of the third leg of the capacitor-clamped multi-level inverter and a neutral point of the electric motor to the charging station; and
control at least one of the first set of switches to control a first current through the first AC terminal of the first leg and the second set of switches to control a second current through the second AC terminal of the second leg to charge the battery via the charging station through the electric motor.

9. The system of claim 8, wherein the processor is further configured to control the first current by controlling a first switching cycle for the first set of switches of the first leg and to control the second current by controlling a second switching cycle for the second set of switches of the second leg.

10. The system of claim 9, wherein the first leg includes a switch pair and the processor is further configured provide a carrier signal to the switch pair, wherein switches of the switch pair receive inputs that are out of phase by 180 degrees.

11. The system of claim 8, wherein the processor is further configured 50 control a first magnitude of the first current and a second magnitude of the second current to generate a net zero torque at the electric motor for any angular location of a rotor of the electric motor.

12. The system of claim 8, wherein the third AC terminal is connected to the charging station and the processor is further configured to place each switch of the third set of switches in an open state.

13. The system of claim 8, wherein the third AC terminal is connected to the charging station and the third set of switches includes four switches in series and the processor is further configured to place a first switch and a third switch of the third leg in a closed state and place a second switch and a fourth switch of the third leg in an open state to connect a clamping capacitor of the third leg across the charging station.

14. The system of claim 8, wherein the neutral point of the electric motor is connected to the charging station and the processor is further configured to operate the first set of switches, the second set of switches and the third set of switches out of phase with each other by 120 degrees.

15. A vehicle, comprising:
a battery;
an electric motor couplable to a charging station;
a capacitor-clamped multi-level inverter that includes a first leg having a first set of switches and a first AC terminal coupled to the electric motor, a second leg having a second set of switches and a second AC terminal coupled to the electric motor and a third leg having a third set of switches and a third AC terminal coupled to the electric motor, wherein the capacitor-clamped multi-level inverter is configured to couple the electric motor to the battery;
processor configured to:
connect one of the third AC terminal of the third leg of the capacitor-clamped multi-level inverter and a neutral point of the electric motor to the charging station; and
control at least one of the first set of switches to control a first current through the first AC terminal of the first leg and the second set of switches to control a second current through the second AC terminal of the second leg to charge the battery via the charging station through the electric motor.

16. The vehicle of claim 15, wherein the processor is further configured to control the first current by controlling a first switching cycle for the first set of switches of the first leg and to control the second current by controlling a second switching cycle for the first set of switches of the second leg.

17. The vehicle of claim 16, wherein the first leg includes a switch pair and the processor is further configured provide a carrier signal to the switch pair, wherein switches of the switch pair receive inputs that are out of phase by 180 degrees.

18. The vehicle of claim 15, wherein the processor is further configured to control a phase between the first current and the second current to generate a net zero torque at the electric motor for any angular location of a rotor of the electric motor.

19. The vehicle of claim 15, wherein the third AC terminal is connected to the charging station, the third set of switches including four switches in series, the processor being further configured to perform at least one of: (i) place each switch of the third set of switches in an open state; and (ii) place a first switch and a third switch of the third leg in a closed state and place a second switch and a fourth switch of the third leg in an open state to connect a clamping capacitor of the third leg across the charging station.

20. The vehicle of claim 15, wherein the neutral point of the electric motor is connected to the charging station and the processor is further configured to operate the first set of switches, the second set of switches and the third set of switches out of phase with each other by 120 degrees.
